(19) United States
(12) Patent Application Publication
(10) Pub. No.: US 2008/0148190 A1
(43) Pub. Date: Jun. 19, 2008

(54) MULTI-LEVEL GRAPHICAL USER INTERFACES

(75) Inventor: Cody J. Schaff, Durango, CO (US)

Correspondence Address: SAWYER LAW GROUP LLP, P.O. BOX 51418, PALO ALTO, CA, 94303, US

(73) Assignee: International Business Machines Corporation, Armonk, NY (US)

(21) Appl. No.: 11/611,101

(22) Filed: Dec. 14, 2006

(51) Int. Cl. G06F 3/048

(52) U.S. Cl. 715/853

(57) ABSTRACT

A method and a computer program product for directing users to locations within multi-level interfaces are provided. The method and the computer program product provide for graphically displaying an expandable hierarchical tree structure interface to a user, the expandable hierarchical tree structure interface comprising a plurality of nodes, identifying a target location within the expandable hierarchical tree structure interface responsive to an event, determining a path within the expandable hierarchical tree structure interface leading to the target location, the path being a traversal through a subset of the plurality of nodes within the expandable hierarchical tree structure interface, and visually highlighting each node in the path to direct the user to the target location.

### FIELD OF THE INVENTION

The present invention relates generally to multi-level graphical user interfaces.

### BACKGROUND OF THE INVENTION

Multi-level graphical user interfaces are frequently used in computer systems to help users to navigate through, for instance, components and/or contents of a system, an application, a folder, a file, etc. As an example, contents of an application help file are often displayed as an expandable hierarchical tree structure interface with higher level nodes representing general topics or subjects (e.g., customization) and lower level nodes representing more specific topics or subjects (e.g., customizing display, customizing output, etc.). Typically, the expandable hierarchical tree structure interface is initially displayed in unexpanded form, i.e., with only high level node(s) visible. A user can then expand a node by selecting the node using an input device, such as a mouse, and traverse through the tree.

As systems, applications, and so forth become increasingly complex, however, a multi-level interface (e.g., an expandable hierarchical tree structure) may begin to include an unmanageable number of objects (e.g., nodes) per level. In addition, each object may have numerous children with each child possibly having children of its own. Hence, there is a need for a mechanism to direct or guide users to a specific part or parts of hierarchical structures.

### SUMMARY OF THE INVENTION

A method and a computer program product for directing users to locations within multi-level interfaces are provided. The method and the computer program product provide for graphically displaying an expandable hierarchical tree structure interface to a user, the expandable hierarchical tree structure interface comprising a plurality of nodes, each of the plurality of nodes being on one of a plurality of levels of the expandable hierarchical tree structure interface, identifying a target location within the expandable hierarchical tree structure interface responsive to an event, determining a path within the expandable hierarchical tree structure interface leading to the target location, the path being a traversal through a subset of the plurality of nodes within the expandable hierarchical tree structure interface, and visually highlighting each node in the path to direct the user to the target location.

### BRIEF DESCRIPTION OF THE DRAWINGS

FIG. 1 depicts a process flow of a method for directing users to locations within multi-level interfaces according to an implementation of the invention.

FIGS. 2A-2D illustrate graphical displays of a sample expandable hierarchical tree structure interface at various states according to an implementation of the invention.

FIG. 3 shows a modified version of the sample expandable hierarchical tree structure interface.

FIG. 4 is a partial graphical display of a sample expandable hierarchical tree structure interface according to an implementation of the invention.

FIG. 5 depicts a screen shot of a window displayed to a user according to an implementation of the invention.

FIG. 6 illustrates a block diagram of a data processing system with which implementations of the invention can be implemented.

### DETAILED DESCRIPTION

The present invention relates generally to multi-level graphical user interfaces. The following description is presented to enable one of ordinary skill in the art to make and use the invention and is provided in the context of a patent application and its requirements. The present invention is not intended to be limited to the implementations shown, but is to be accorded the widest scope consistent with the principles and features described herein.

A graphical user interface (GUI) is a computer interface that presents information relating to a system, an application, a folder, a file, and so forth, using, for instance, graphics, icons, pictures, and/or text, and allows users to interact with the system, application, folder, file, and so forth through the graphics, icons, pictures, and/or text. For example, an application can be displayed to a user as an icon with a name of the application in text; the user can then open the application by double-clicking on the icon using an input device (e.g., a mouse, a track ball, a touch pad, a pointing stick, etc.).

Components and/or contents of a system, an application, a folder, a file, etc. are usually displayed as a multi-level graphical user interface to make it easier for users to navigate through the system, application, folder, file, etc. As an example, various components, folders, files, programs, etc. of a computer system can be displayed as nodes of an expandable hierarchical tree structure interface. The tree at its highest level may include a node that represents the computer system itself. Hence, when the tree is unexpanded, it may only include a single node.

At a next level, the tree may include various nodes corresponding to components of the computer system. For instance, each hard drive of the computer system may have a corresponding node in the tree, each disk drive of the computer system may also have a corresponding node in the tree, and so forth. These nodes could be displayed as child nodes of the computer system node. In addition, each of the nodes may have its own child nodes. For example, a node representing a hard drive may have child nodes representing folders stored on the hard drive. A node representing a folder may then have child nodes representing files, applications, and/or other folders stored within the folder. Users can navigate through the tree by expanding nodes on various levels of the tree.

Computer systems, however, are becoming increasingly complex. As a result, users may find it difficult to locate a certain object(s), such as nodes, within multi-level interface(s), such as expandable hierarchical tree structures, since the number of objects per level may be too numerous. Current multi-level interfaces only display objects that have been selected by a user and each selected object's children, if any. Thus, if a particular object sought by the user is not currently displayed because a higher level object leading to the particular object has not been selected for expansion, it may take the user awhile to find the particular object.

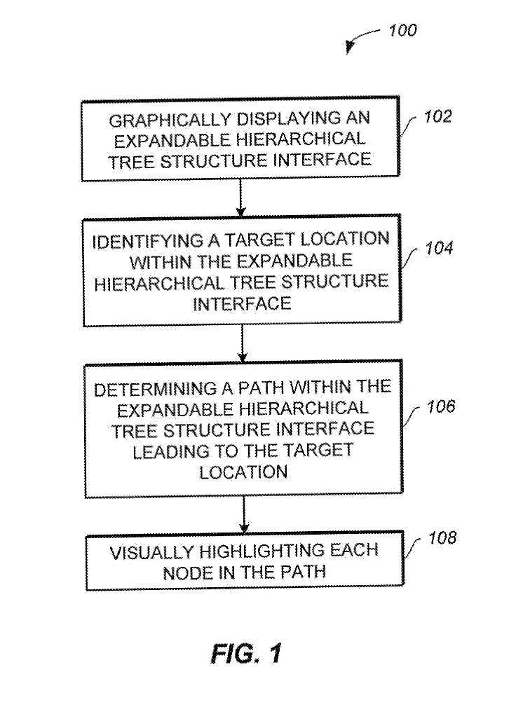

FIG. 1 depicts a process 100 for directing users to locations within multi-level interfaces according to an implementation of the invention. At 102, an expandable hierarchical tree structure interface is graphically displayed to a user. The expandable hierarchical tree structure interface includes a plurality of nodes. Each of the plurality of nodes is on one of a plurality of levels of the expandable hierarchical tree structure interface and is selectable by the user via a provided input device. In one implementation, each of the plurality of nodes corresponds to one of an application, a folder, a file, a topic, a component, and a resource.

A node on a first level of the expandable hierarchical tree structure interface is a parent node when one or more other nodes on a second level of the expandable hierarchical tree structure interface are revealed responsive to selection of the node on the first level by the user. The one or more other nodes on the second level are child nodes of the parent node.

At 104, a target location within the expandable hierarchical tree structure interface is identified responsive to an event. In one implementation, the event is an occurrence of an error at the target location within the expandable hierarchical tree structure interface or a performance of a search on the plurality of nodes in the expandable hierarchical tree structure interface, wherein a result of the search performed includes the target location. The target location is one or more child nodes within the expandable hierarchical tree structure interface.

A path within the expandable hierarchical tree structure interface leading to the target location is determined at 106. The path is a traversal through a subset of the plurality of nodes within the expandable hierarchical tree structure interface. At 108, each node in the path is visually highlighted to direct the user to the target location. A node in the path is visually highlighted responsive to the node being graphically displayed to the user. For instance, if a node in the path is not graphically displayed to the user because a parent node has not been expanded through a user selection, then that node need not be visually highlighted since it is not visible to the user.

In one implementation, visually highlighting each node in the path includes at least one of placing a special icon at each node in the path, changing a text of each node in the path, replacing the text of each node in the path, changing a color of each node in the path, changing a behavior of each node in the path, replacing an icon at each node in the path with a replacement icon, or providing additional information at one or more nodes in the path. Each node need not be visually highlighted in the same manner.

Changing the text of each node in the path may include changing a font of the text of each node in the path (e.g., changing from Courier font to Arial font), changing a font size of the text of each node in the path (e.g., changing from 12 point font to 16 point font), changing a font style of the text of each node in the path (e.g., changing from regular font style to bold/italic/underline font style), and/or changing a font color of the text of each node in the path (e.g., changing from black font color to red font color).

There may be more than one path to the target location. For example, if the target location is a plurality of nodes identified in response to a search request, different paths may lead to different target nodes. In addition, one target node may be of more interest than another target node because it is a closer match to the search request. Thus, providing additional information (e.g., matching percentage) at, for instance, a highest level node in each path can help the user to make decisions regarding which of the paths the user may wish to follow.

If a special icon or a replacement icon is placed at each node in the path to the target location, the special icon or the replacement icon may be implemented as clickable targets (e.g., selectable by the user via the provided input device) such that in response to selection by the user, the expandable hierarchical tree structure interface automatically expands to the target location when the target location is not graphically displayed to the user at the time of selection. Additionally, when additional information is provided at one or more nodes in the path, the additional information can also be implemented as a clickable target.

By visually highlighting each node of an expandable hierarchical tree structure interface that is needed to reach a target location at each level of expansion, a user can easily locate the target node(s) by following visual markers that indicate subsequent steps of a path leading to the target location. In addition, direct navigation from any level of expansion to a target location can be provided by implementing an icon or additional information as clickable targets.

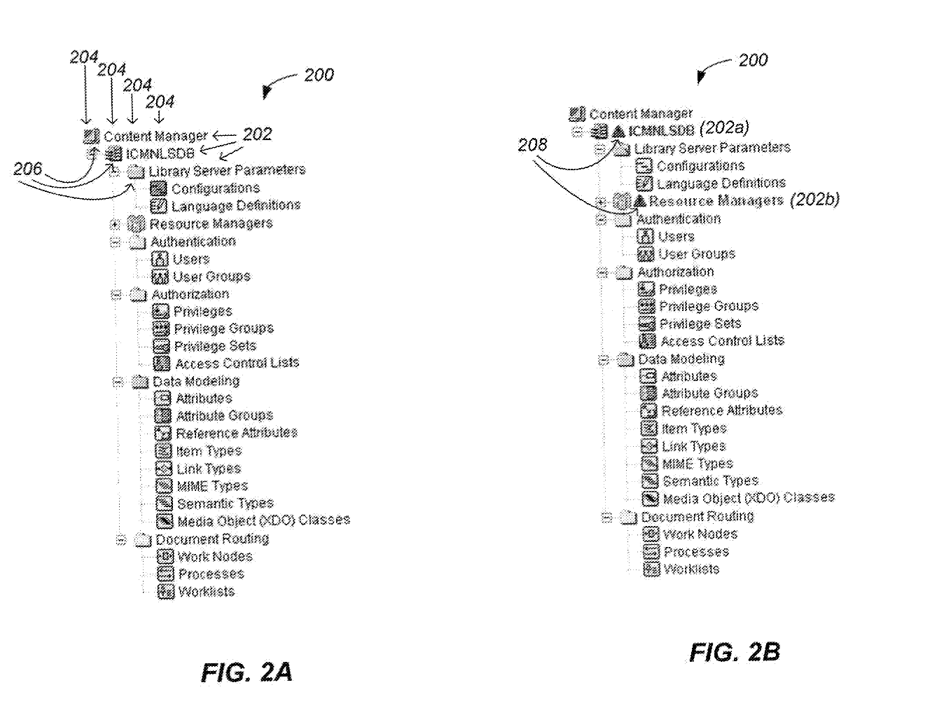

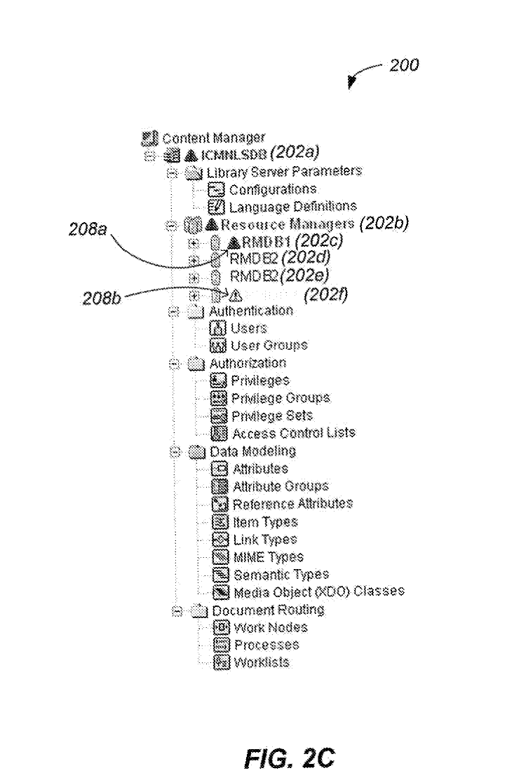

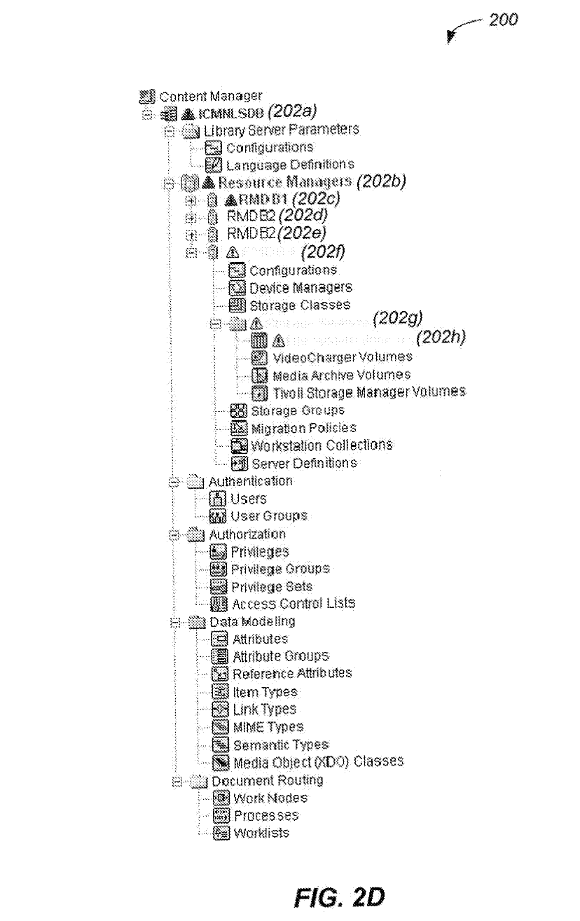

Illustrated in FIGS. 2A-2D are graphical displays of a sample expandable hierarchical tree structure interface 200 at various states according to an implementation of the invention. Expandable hierarchical tree structure interface 200 includes a plurality of nodes 202 at a plurality of levels 204. Some of the nodes 202 correspond to applications (e.g., “Content Manager” node), folders (e.g., “Authentication” node), etc. As illustrated in FIG. 2A, an icon 206 has been placed at each of the nodes 202. In FIG. 2A, expandable hierarchical tree structure interface 200 has been partially expanded. Since no events have occurred, none of the nodes of expandable hierarchical tree structure interface 200 have been visually highlighted.

In FIG. 2B, an event has occurred and two of the nodes 202a and 202b have been visually highlighted by placing special icons 208 at nodes 202a and 202b and changing the text of nodes 202a and 202b. The indicators inform a user viewing expandable hierarchical tree structure interface 200 that certain descendant node or nodes of the “Resource Managers” node 202b are of particular interest. If at the time the event occurs, the user is performing another task, the user can complete the other task before proceeding to the nodes that have been highlighted in response to the event.

Special icons 208 can be implemented as clickable targets such that when the user selects one of the special icons 208, expandable hierarchical tree structure interface 200 automatically expands to the node(s) that are of particular interest. The user can also expand the tree on a level by level basis. As illustrated in FIG. 2C, expandable hierarchical tree structure interface 200 has been expanded to reveal four descendant nodes 202c-202f of the “Resource Managers” node 202b.

In the example of FIG. 2C, nodes 202c and 202f are visually highlighted in different ways to indicate different statuses. “RMDB1” node 202c has been highlighted using a darker color and a darker special icon 208a to indicate one or more descendants of the node 202c may have a critical issue. On the other hand, “RMDB4” node 202f has been highlighted using a lighter color and a lighter special icon 208b to indicate one or more descendants of the node 202f may have a moderate issue.

FIG. 2D illustrates expandable hierarchical tree structure interface 200 expanded to a target node 202h, which is a child of node 202g. Node 202g is, in turn, a child of “RMDB4” node 202f. As seen in FIG. 2D, each node along the path to target node 202h has been visually highlighted, though not necessarily with the same indicators.

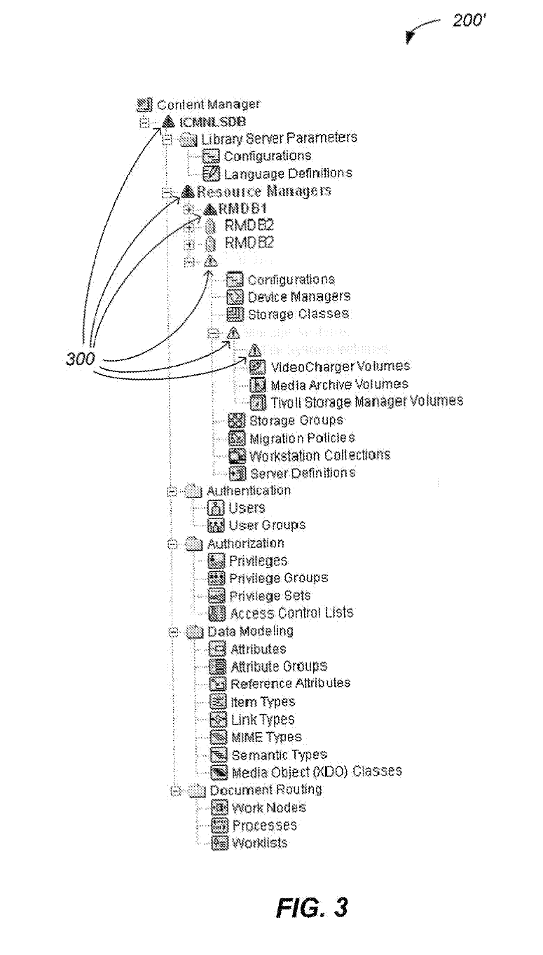

FIG. 3 shows a modified version 200′ of the expandable hierarchical tree structure interface 200 illustrated in FIGS. 2A-2D. In FIG. 3, rather than placing a special icon at each node in the paths leading to target node(s), icons 206 (illustrated in FIGS. 2A-2D) at each node in the paths have been replaced with a replacement icon 300. As with special icons 208, replacement icons 300 can be implemented as clickable targets to provide direct access to target node(s).

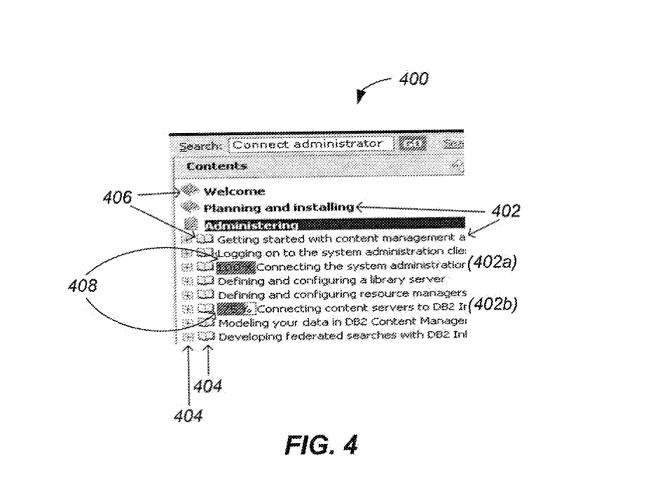

Depicted in FIG. 4 is a graphical display of a sample expandable hierarchical tree structure interface 400 according to an implementation of the invention. Expandable hierarchical tree structure interface 400 includes a plurality of nodes 402 on a plurality of levels 404. Each of the plurality of nodes 402 has an icon 406. In the implementation, nodes 402 correspond to different topics and subject matter.

A search has been performed in FIG. 4 and additional information 408 have been provided at nodes 402a and 402b, which have descendant(s) that are part of a result set of the search performed. In the example, the additional information 408 provided is a suggested matching percentage to the search performed. This allows a user to make additional judgment about which section of expandable hierarchical tree structure interfaces 400 might be closest to a desired result, as well as give suggestions as to which section of expandable hierarchical tree structure interface 400 might include the desired result.

Although special icons 208 in FIGS. 2A-2D, replacement icons 300 in FIG. 3, and additional information 408 in FIG. 4 have been illustrated as being to the left of each node, they do not necessarily have to be placed as such. For example, such indicators may be placed to the right of each node rather than to the left, as part of a background image behind the text, as an integrated combination of graphics and text, etc.

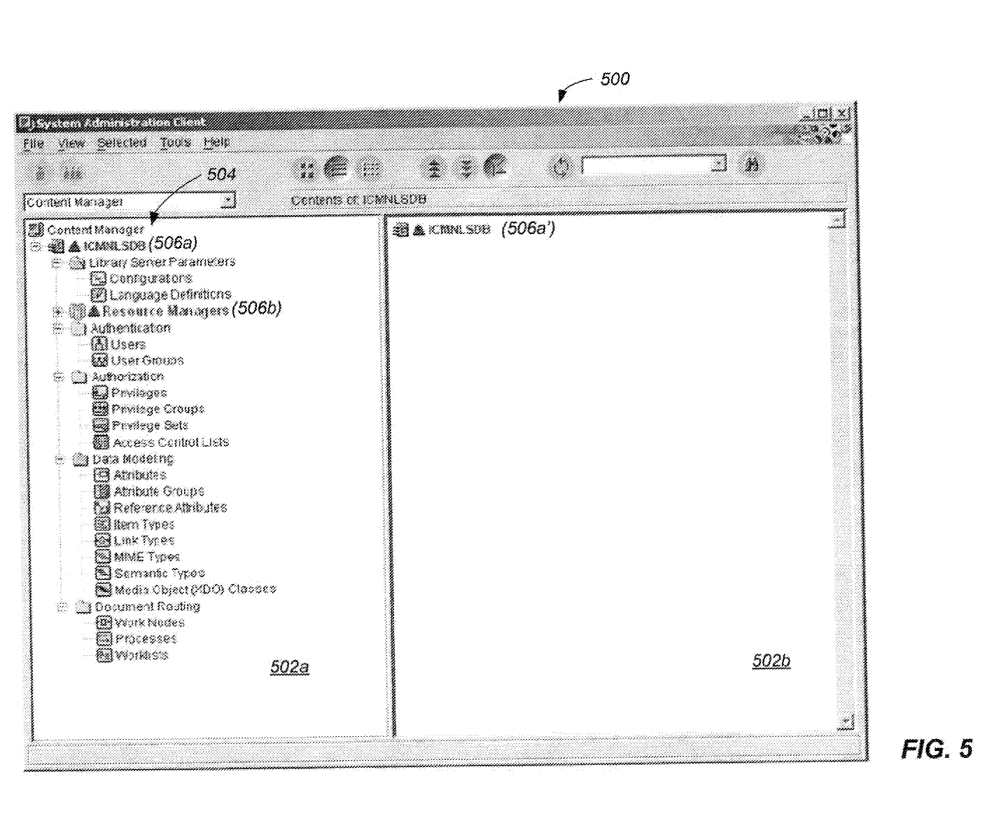

FIG. 5 illustrates a screen shot of a window 500 displayed to a user according to an implementation of the invention. Window 500 includes two areas 502a and 502b which are sometimes called panes or frames. In area 502a, an expandable hierarchical tree structure interface 504 is graphically displayed. Two nodes 506a and 506b of expandable hierarchical tree structure interface 504 have been visually highlighted in response to an event. In the implementation, in addition to visually highlighting nodes of a path leading to a target location, a duplicate of at least one of the nodes in the path is graphically displayed separate from expandable hierarchical tree structure interface 504. As seen in FIG. 5, a duplicate of node 506a′ is displayed in area 502b.

Displaying a duplicate of a node in a path leading to a target location separate from an expandable hierarchical tree structure interface containing the node is an additional way to provide notice to a user regarding the occurrence of an event and to identify nodes of the expandable hierarchical tree structure interface in the path leading to the target location. The separate display may be especially helpful when the user is viewing a section of the expandable hierarchical tree structure interface where none of the nodes in the path leading to the target location are visible.

For example, a user may not be able to see all of the nodes of an expandable hierarchical tree structure interface at the same time due to display limitations. Hence, if the user is viewing a bottom section of the interface when an event occurs relating to one or more nodes near a top section of the interface that are not visible to the user, separately displaying a duplicate of at least one node in a path leading to the one or more nodes will alert the user to the event.

The invention can take the form of an entirely hardware implementation, an entirely software implementation, or an implementation containing both hardware and software elements. In one aspect, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W).

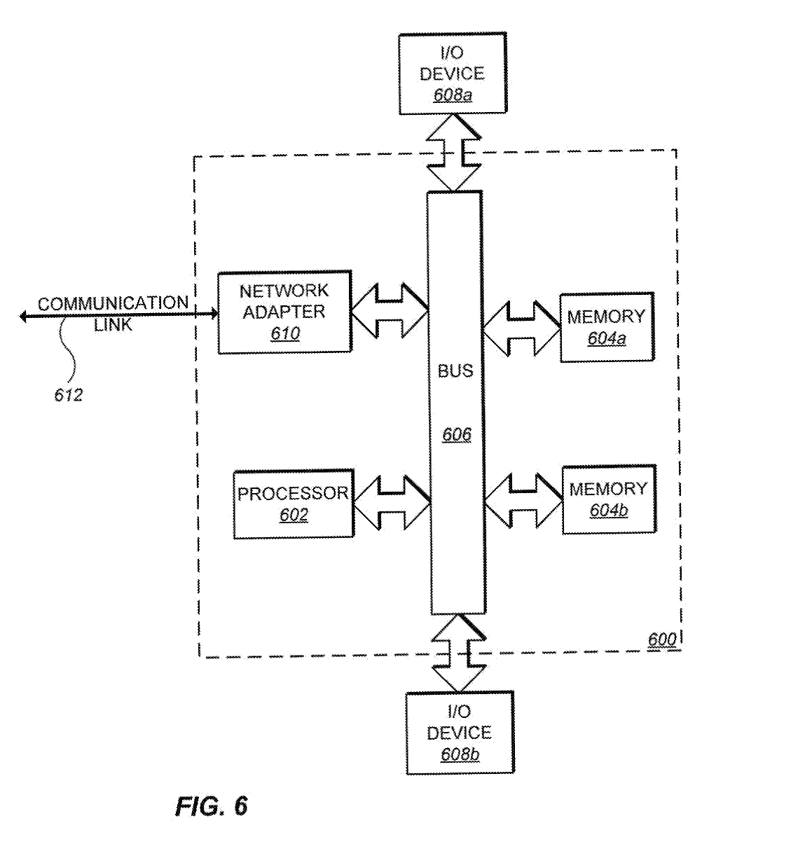

Shown in FIG. 6 is a data processing system 600 suitable for storing and/or executing program code. Data processing system 600 includes a processor 602 coupled to memory elements 604a-b through a system bus 606. In other implementations, data processing system 600 may include more than one processor and each processor may be coupled directly or indirectly to one or more memory elements through a system bus.

Memory elements 604a-b can include local memory employed during actual execution of the program code, bulk storage, and cache memories that provide temporary storage of at least some program code in order to reduce the number of times the code must be retrieved from bulk storage during execution. As shown, input/output or I/O devices 608a-b (including, but not limited to, keyboards, displays, pointing devices, etc.) are coupled to data processing system 600. I/O devices 608a-b may be coupled to data processing system 600 directly or indirectly through intervening I/O controllers (not shown).

In the implementation, a network adapter 610 is coupled to data processing system 600 to enable data processing system 600 to become coupled to other data processing systems or remote printers or storage devices through communication link 612. Communication link 612 can be a private or public network. Modems, cable modems, and Ethernet cards are just a few of the currently available types of network adapters.

While various implementations for directing users to locations within a multi-level interfaces have been described, the technical scope of the present invention is not limited thereto. Various modifications or improvements can be added to the above implementations and those modifications or improvements fall within the technical scope of the present invention

What is claimed is:

1. A method for directing users to locations within multi-level interfaces, the method comprising:
graphically displaying an expandable hierarchical tree structure interface to a user, the expandable hierarchical tree structure interface comprising a plurality of nodes, each of the plurality of nodes being on one of a plurality of levels of the expandable hierarchical tree structure interface, corresponding to one of an application, a folder, a file, a topic, a component, and a resource, and being selectable by the user via a provided input device,
wherein a node on a first level of the expandable hierarchical tree structure interface is a parent node when one or more other nodes on a second level are revealed responsive to selection of the node on the first level by the user, the one or more other nodes on the second level being child nodes of the parent node;
identifying a target location within the expandable hierarchical tree structure interface responsive to an event, the target location being one or more child nodes within the expandable hierarchical tree structure interface;
determining a path within the expandable hierarchical tree structure interface leading to the target location, the path being a traversal through a subset of the plurality of nodes within the expandable hierarchical tree structure interface; and
visually highlighting each node in the path to direct the user to the target location, wherein visually highlighting each node in the path comprises at least one of
placing a special icon at each node in the path,
changing a text of each node in the path,
replacing the text of each node in the path,
changing a color of each node in the path,
changing a behavior of each node in the path,
replacing an icon at each node in the path with a replacement icon, or
providing additional information at one or more nodes in the path,
wherein a node in the path is visually highlighted responsive to the node being graphically displayed to the user.

2. The method of claim 1, wherein the event is an occurrence of an error at the target location within the expandable hierarchical tree structure interface or a performance of a search on the plurality of nodes in the expandable hierarchical tree structure interface, wherein a result of the search performed includes the target location.

3. The method of claim 1, wherein changing the text of each node in the path comprises at least one of changing a font of the text of each node in the path, changing a font size of the text of each node in the path, changing a font style of the text of each node in the path, and changing a font color of the text of each node in the path.

4. The method of claim 1, wherein the special icon, the replacement icon, and the additional information are clickable targets such that in response to selection by the user, the expandable hierarchical tree structure interface automatically expands to the target location when the target location is not graphically displayed to the user at the time of selection.

5. The method of claim 1, further comprising:
graphically displaying a duplicate of at least one node in the path separate from the expandable hierarchical tree structure interface.

6. A computer program product comprising a computer readable medium, the computer readable medium including a computer readable program for directing users to locations within multi-level interfaces, wherein the computer readable program when executed on a computer causes the computer to:
graphically display an expandable hierarchical tree structure interface to a user, the expandable hierarchical tree structure interface comprising a plurality of nodes, each of the plurality of nodes being on one of a plurality of levels of the expandable hierarchical tree structure interface, corresponding to one of an application, a folder, a file, a topic, a component, and a resource, and being selectable by the user via a provided input device,
wherein a node on a first level of the expandable hierarchical tree structure interface is a parent node when one or more other nodes on a second level are revealed responsive to selection of the node on the first level by the user, the one or more other nodes on the second level being child nodes of the parent node;
identify a target location within the expandable hierarchical tree structure interface responsive to an event, the target location being one or more child nodes within the expandable hierarchical tree structure interface;
determine a path within the expandable hierarchical tree structure interface leading to the target location, the path being a traversal through a subset of the plurality of nodes within the expandable hierarchical tree structure interface; and
visually highlight each node in the path to direct the user to the target location, wherein visually highlight each node in the path comprises at least one of
place a special icon at each node in the path,
change a text of each node in the path,
replace the text of each node in the path
change a color of each node in the path,
change a behavior of each node in the path,
replace an icon at each node in the path with a replacement icon, or
provide additional information at one or more nodes in the path,
wherein a node in the path is visually highlighted responsive to the node being graphically displayed to the user.
